(19) United States
(12) Patent Application Publication
(10) Pub. No.: US 2010/0013186 A1
(43) Pub. Date: Jan. 21, 2010

(54) POWERED RETRACTABLE MOTORCYCLE STAND

(76) Inventor: Alcide G. Markie, Avon, CT (US)

Correspondence Address: Russ Weinzimmer, 614 Nashua Street, Suite 53, Milford, NH, 03055, US

(21) Appl. No.: 12/173,878

(22) Filed: Jul. 16, 2008

(51) Int. Cl. B62H 1/06; B62H 5/00

(52) U.S. Cl. 280/297; 280/304; 180/219; 74/422

(57) ABSTRACT

A fully powered motorcycle stand is disclosed that is attachable to a motorcycle undercarriage and is able to extend legs on either side of the motorcycle. The legs are extended by a leg extending mechanism, such as an electric motor or a hydraulic pump and piston. Legs can include tubular and/or solid bars, and can have feet attached to the leg bottom. The legs can be connected, such as by a crossbar, or if not connected, can be separately extendable to different lengths so as to support the motorcycle vertically on uneven terrain. A stand controller sends control commands to the leg extending mechanism. A safety mechanism can be included that prevents leg extension while the motorcycle is moving, and an anti-theft system can be included that prevents leg retraction without a key or passcode.

### FIELD OF THE INVENTION

This invention relates generally to motorcycle stands, and in particular to powered motorcycle stands.

### BACKGROUND OF THE INVENTION

Motorcycles, mopeds, motorbikes, motor scooters, and the like (herein referred to generically as motorcycles) require stands (herein referred to as motorcycle stands) that can maintain them in a substantially vertical orientation when they are not in use. The most common types of motorcycle stands are manually operated. Manually operated stands that deploy on only one side of a motorcycle are easy to operate, but do not provide good stability, especially on uneven or soft ground. Also, these stands maintain the motorcycle in a somewhat tilted orientation, so that a rider must physically lift the motorcycle back to a vertical orientation before retracting the stand, which can be difficult when the motorcycle is large and/or heavy.

Manually operated motorcycle stands that deploy on both sides of a motorcycle provide more stability than stands that deploy on only one side, but typically require even more physical effort to deploy, since a rider must use his or her foot to hold the legs of the stand against the ground while pulling the motorcycle up onto the stand. This can be awkward, difficult, or even impossible for some riders, since large and heavy motorcycles can weigh 800 pounds or more.

One approach to solving this problem is to use a fully powered motorcycle stand, which eliminates the need for a rider to exert the effort required by a manual stand. However, most fully powered motorcycle stands can be deployed only on one side of a motorcycle and use only one leg, thereby providing less than optimal stability, especially on uneven terrain. Fully powered motorcycle stands that can be deployed on both sides of a motorcycle provide greater stability, but are typically complex and bulky, making them costly and difficult to adapt to many motorcycle designs, and causing them to significantly detract from the visual appearance of the motorcycle.

### SUMMARY

A fully powered motorcycle stand is claimed that extends legs on either side of a motorcycle and is simple, compact, and attachable to the undercarriage of the motorcycle, thereby minimizing its impact on the visual appearance of the motorcycle. Depending on the embodiment, the motorcycle stand is attachable to the undercarriage in front of the motor of the motorcycle, or behind the motor of the motorcycle. The motorcycle stand can be attached as one unit, or it can consist of separate units, such as two separately attachable telescoping legs, both operated by a common control unit. The legs of the motorcycle stand are extendable by a leg extending mechanism, which can be an electric motor, a hydraulic pump and piston, and/or some other leg extending mechanism. A stand controller sends a command, for example through electronic circuitry, which causes the leg extending mechanism to extend or retract the legs. In some preferred embodiments the legs are connected by a crossbar, while in other preferred embodiments the legs can be separately extended so as to automatically adapt to uneven terrain. A safety mechanism can be included that prevents the legs from extending while the motorcycle is moving, and an anti-theft system can be included that prevents retraction of the stand without a key or a passcode.

The invention is a powered motorcycle stand that includes at least two legs that are attachable to a motorcycle undercarriage, the legs being extendable to a right side and a left side of the motorcycle so as to support the motorcycle in a standing orientation. The stand includes a powered leg extending mechanism that is able to extend and retract the legs, and a stand controller that is able to control the powered leg extending mechanism. In preferred embodiments, the legs are attachable to the motorcycle by welding, fastening with brackets, fastening with bolts, and/or fastening with clamps. The legs can include tubular and/or solid steel bars, and can also include at least one connecting crossbar. In some preferred embodiments the legs are at least partly housed in a stand frame when retracted, and/or the legs are telescopically extendable. In other preferred embodiments, the invention further includes a plurality of feet, with one foot connected to the bottom of each leg.

In some preferred embodiments, the powered leg extending mechanism includes an electric motor, for example a motor which is able to apply a rotational force to a driving gear. In preferred embodiments, at least one of the legs includes a toothed side and/or a toothed channel that the driving gear can engage with, so as to cause the leg to be extended or retracted when the electric motor applies a rotational force to the driving gear. In other preferred embodiments, the powered leg extending mechanism includes a hydraulic pump and piston.

In certain preferred embodiments, the motorcycle stand is able to provide optimal stability when the motorcycle is located on uneven terrain by extending the legs to different lengths, such that the legs support the motorcycle in an upright position. In some of these embodiments, the motorcycle stand unit includes one or more sensors that detect the force of resistance against extended legs, and/or the lateral tilt of the motorcycle, and these sensors are used to control the unequal extension of the legs such that the motorcycle is maintained in a vertical orientation.

In preferred embodiments, the motorcycle stand is designed such that the visibility of the stand is minimized when the legs are retracted. In some preferred embodiments, the stand controller includes a manually operable control affixed to a dashboard of the motorcycle. In further preferred embodiments, the motorcycle stand includes a locking mechanism that is able to lock the legs in place. In still other preferred embodiments, the stand controller includes an anti-theft system that is able to inhibit an unauthorized user from retracting the legs. Such an anti-theft system can require at least one of insertion of a key and entry of a code so as to initiate retracting of the legs.

In some other preferred embodiments, the motorcycle stand controller includes an automatic safety system that automatically retracts the legs and/or automatically prevents extension of the legs when the motorcycle is in motion. The safety system can include a sensor that detects when at least one wheel of the motorcycle is rotating.

### BRIEF DESCRIPTION OF THE DRAWINGS

FIG. 1 is a side view of a motorcycle, showing a deployed stand in an embodiment where the stand is attached to the undercarriage of the motorcycle in front of the motor, and the legs are connected by a crossbar;

FIG. 2 is a side view of a motorcycle, showing a deployed stand in an embodiment where the stand is attached to the undercarriage of a motorcycle behind the motor, and the legs are connected by a crossbar;

FIG. 3A illustrates a retracted stand in a preferred embodiment in which straight, mechanically extendable legs are connected by a crossbar and, when fully retracted as shown, are housed within a vertically upright stand frame;

FIG. 3B illustrates the preferred embodiment of FIG. 3A, with the legs having been fully extended by a single, mechanically driven gear;

FIG. 4A is an oblique side view of the preferred embodiment of FIG. 3A;

FIG. 4B is an oblique side view of the preferred embodiment of FIG. 3B;

FIG. 5A illustrates a retracted stand in a preferred embodiment in which curved, mechanically extendable legs are connected by a crossbar and are housed within a curved stand frame when fully retracted, as shown;

FIG. 5B illustrates the preferred embodiment of FIG. 5A, with the legs having been fully extended by a single, mechanically driven gear;

FIG. 6A illustrates a section of a leg of a stand in a preferred embodiment, wherein the leg includes a toothed side that is engaged with a gear rotated by a motor;

FIG. 6B illustrates a section of a leg of a stand in a preferred embodiment wherein the leg includes a toothed channel within a side, the toothed channel being engaged with a gear rotated by a motor;

FIG. 7A illustrates a retracted stand in a preferred embodiment that includes straight, mechanically extendable legs that are connected by a crossbar, as well as foldable feet that are connected to the legs, the legs and feet being housed within a vertically upright stand frame when fully retracted, as shown;

FIG. 7B illustrates the preferred embodiment of FIG. 7A, with the legs having been fully extended by two mechanically driven gears, each gear being engaged with a toothed channel within the outside of a leg;

FIG. 8A illustrates a retracted stand in a preferred embodiment in which straight, hydraulically extendable legs are housed within a vertically upright stand frame when fully retracted, as shown;

FIG. 8B illustrates the preferred embodiment of FIG. 8A, with the legs fully extended;

FIG. 9 is a rear view of a motorcycle, showing a preferred embodiment of the invention attached to the undercarriage of the motorcycle, behind the motor of the motorcycle, with independently extendable legs extended to unequal lengths so as to support the motorcycle in a vertically upright position on uneven terrain;

FIG. 10A illustrates a retracted stand in a preferred embodiment in which straight legs are independently extendable by a mechanical deployment mechanism, and are housed within a vertically upright stand frame when fully retracted as shown;

FIG. 10B illustrates the preferred embodiment of FIG. 10A with the legs having been independently extended by two mechanically driven gears;

FIG. 11A illustrates a retracted stand in a preferred embodiment in which curved legs are independently extendable by a mechanical deployment mechanism, and are housed within a curved stand frame when fully retracted, as shown;

FIG. 11B illustrates the preferred embodiment of FIG. 11A, with the legs having been independently extended by two mechanically driven gears;

FIG. 12 is a flow diagram illustrating the operation of the invention in a preferred embodiment wherein a safety mechanism and an anti-theft system intercept commands sent from a stand control unit to a leg extending mechanism; and

FIG. 13 is a flow diagram illustrating the operation of the invention in a preferred embodiment wherein a stand control unit adjusts the extension of separately extendable stand legs based upon readings from a force sensor and a tilt sensor.

### DETAILED DESCRIPTION OF THE INVENTION

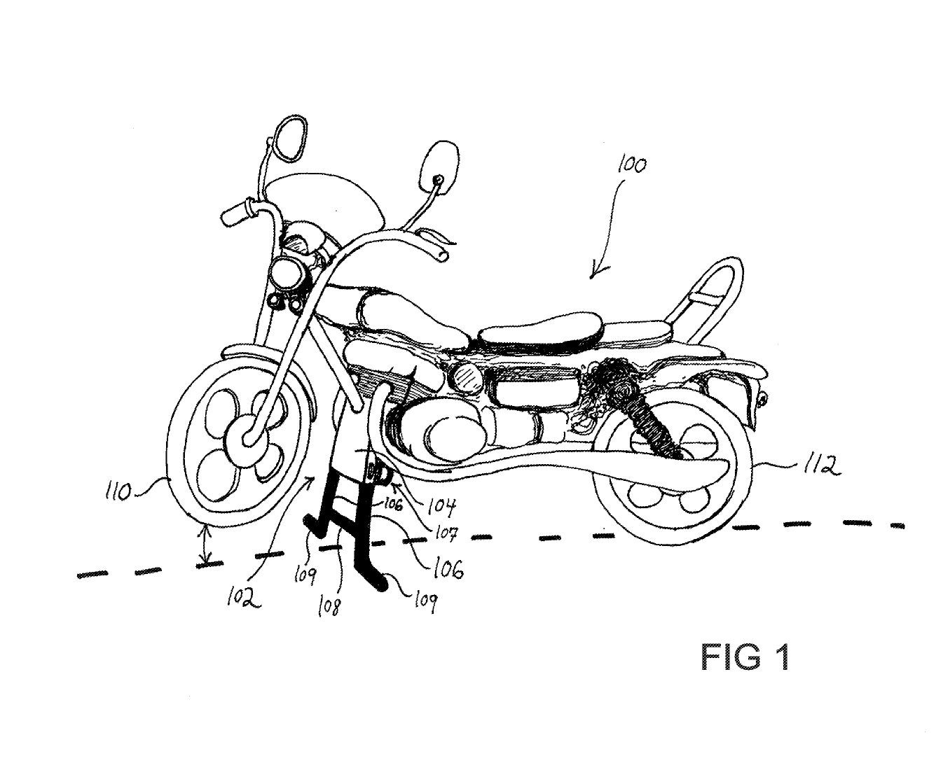

FIG. 1 is a side view of a motorcycle 100, showing a motorcycle stand 102 of the present invention in a preferred embodiment where the motorcycle stand 102 is attached to the undercarriage of the motorcycle 100 in front of the motor of the motorcycle 100. The motorcycle stand 102 includes a stand frame 104 and legs 106 that are mechanically extendable from the stand frame 104, via a leg extending mechanism 107 which includes a motor and a gear. The legs 106 are connected by a crossbar 108, and outward pointing feet 109 are connected to the bottom of the legs 108. In the position shown, the stand 102 is able to lift the front wheel 110 of the motorcycle 100 off of the ground when its legs 106 are fully extended on level terrain. A remote control unit can electronically command the leg extending mechanism 107 to extend or retract the legs 106.

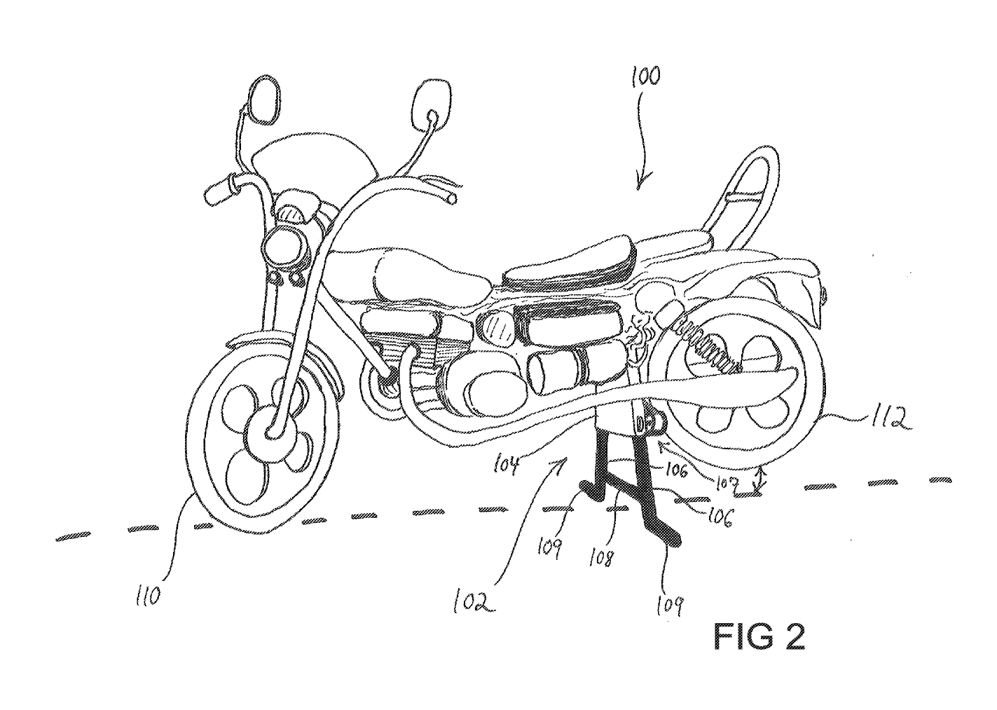

FIG. 2 is a side view of a motorcycle 100, showing an embodiment of a motorcycle stand 102 similar to the embodiment of FIG. 1, except that it is attached to the undercarriage of a motorcycle 100 behind the motor of the motorcycle 100, instead of in front of the motor of the motorcycle 100. As shown in the figure, the stand 102 is able to lift the back wheel 112 of the motorcycle 100 off the ground when its legs 106 are fully extended on level terrain. A remote control unit can electronically command the leg extending mechanism 107 to extend or retract the legs 106.

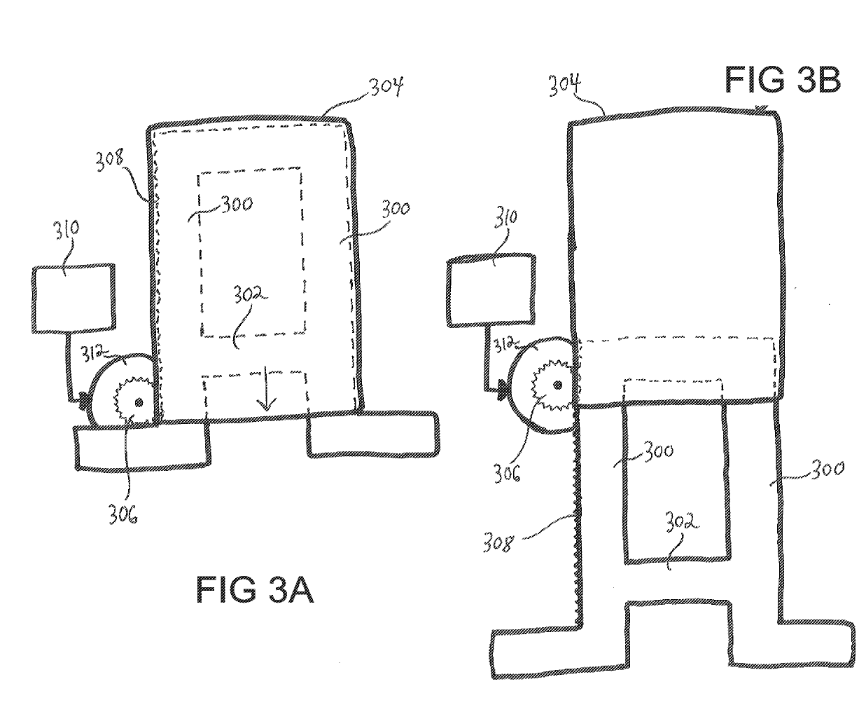

FIG. 3A illustrates a preferred embodiment of the motorcycle stand in which straight, mechanically extendable legs 300 are connected by a crossbar 302 and are fully retracted and housed within a vertically upright stand frame 304. The leg extending mechanism is a motor-driven gear 306 that is connected to a toothed side 308 of one of the legs 300 through a slot in the stand frame 304. FIG. 3B illustrates the same embodiment with the legs 300 fully extended. A control unit 310 electronically sends a command to a motor 312, and the motor 312 rotates the gear 306 so as to extend or retract the legs 300.

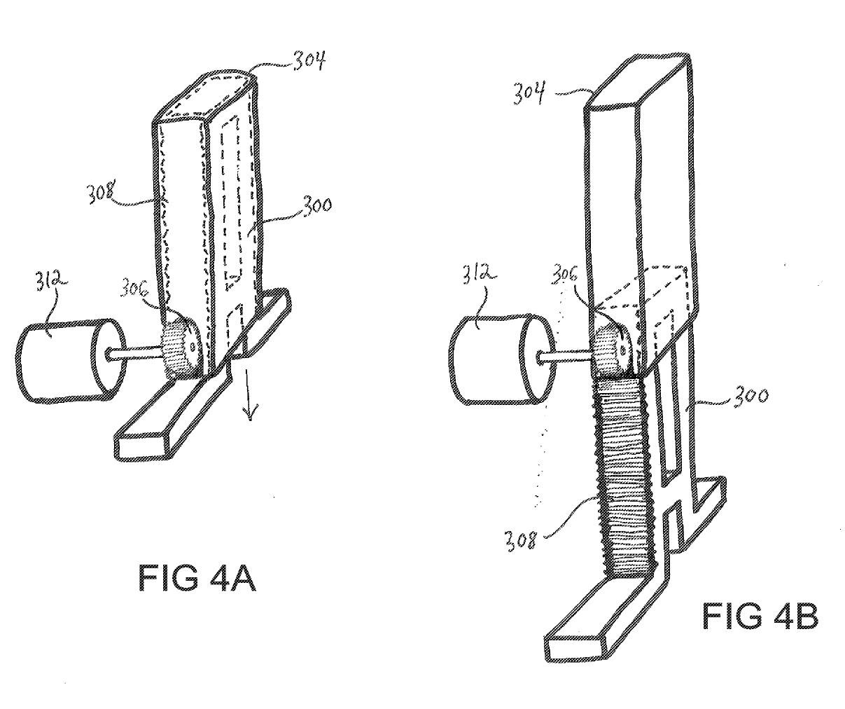

FIG. 4A is an oblique side view of the embodiment shown in FIG. 3A. The gear 310 is shown engaged with a toothed side 308 of the leg 300 through a slot in the stand frame 304, and attached to the motor 312 such that the gear 310 can be mechanically driven by the motor 312. FIG. 4B is an oblique side view of the embodiment of FIG. 3B. As in FIG. 3B, the legs 300 are shown fully extended from the stand frame 304.

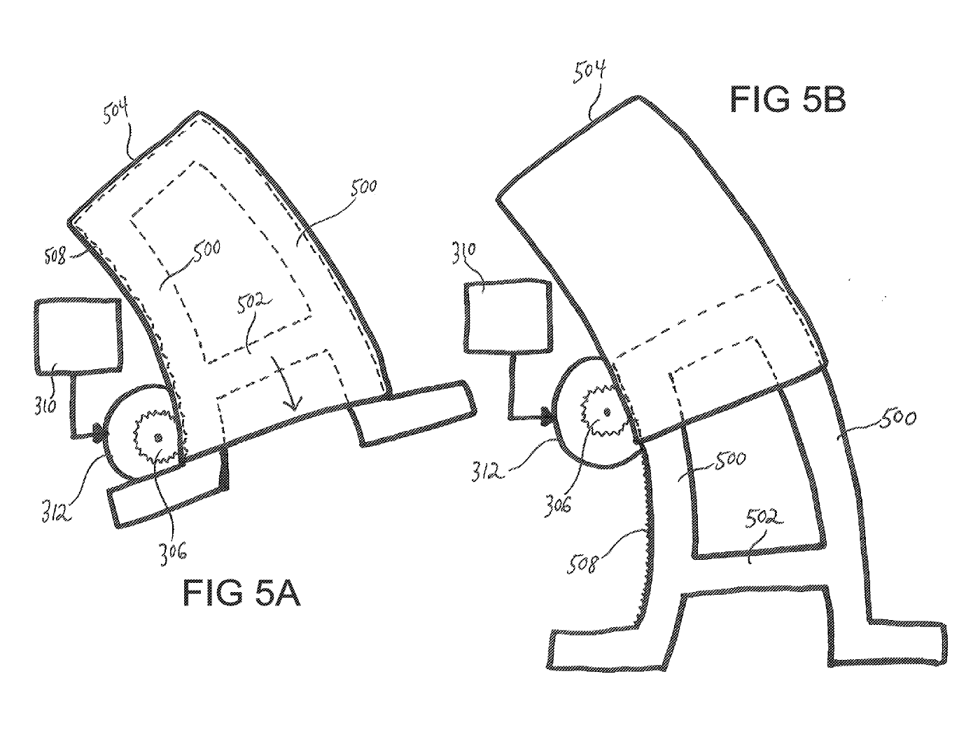

FIG. 5A illustrates a preferred embodiment of the motorcycle stand in which curved, mechanically extendable legs 500 are connected by a crossbar 502 and are fully retracted and housed within a curved stand frame 504. This embodiment is suitable for installation on motorcycles that have an obstruction in the middle of the undercarriage. Although in this embodiment the stand frame is not installed in the middle of the undercarriage, the stand legs 500 extend in an arc so as to contact the ground symmetrically about the center of the motorcycle. As in FIG. 3A and FIG. 3B, a motor-driven gear 306 is shown as part of the leg extending mechanism. The gear 306 is engaged with a toothed side 308 of one of the legs 500 through a slot in the stand frame 504, and the gear 306 is mechanically driven by a motor 312. A control unit 310 electronically sends a command to the motor 312, and the motor 312 rotates the gear 306 so as to extend or retract the legs 500. FIG. 5B illustrates the same embodiment with the legs 500 fully extended from the stand frame 504.

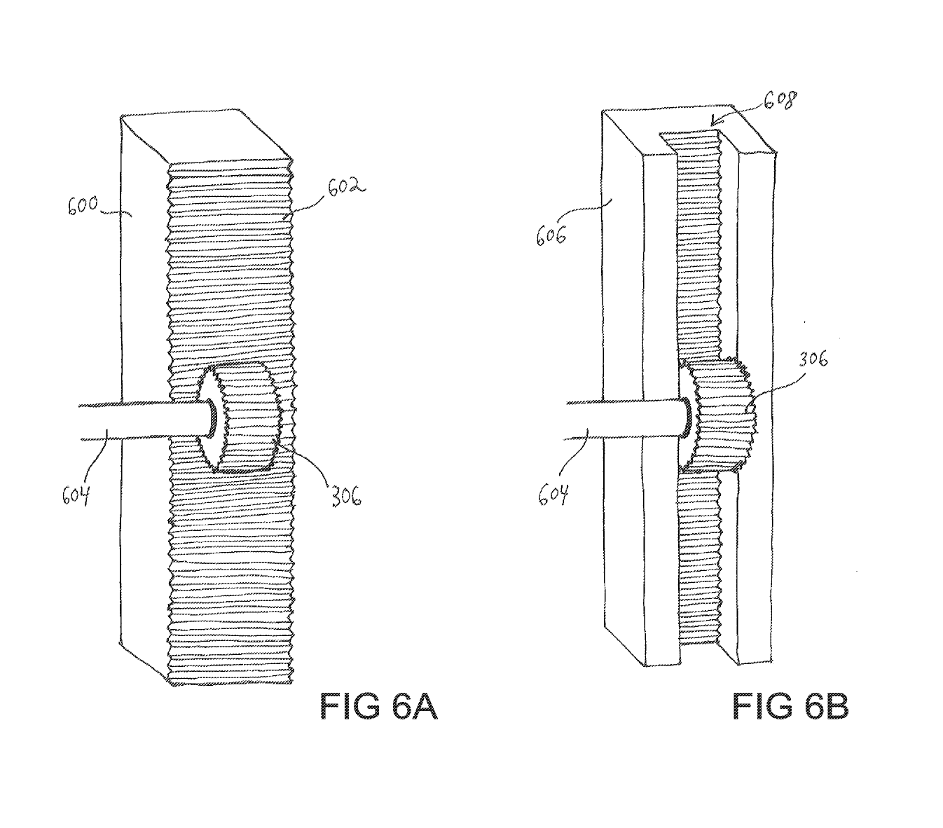

FIG. 6A illustrates a section of a leg 600 of a preferred embodiment, wherein the leg includes a toothed side 602 that can be engaged with a motor-driven gear 306 connected to a motor by a driveshaft 604. FIG. 6B illustrates a section of a leg 606 of a preferred embodiment, wherein the leg includes a toothed channel 608 within a side, such that the gear 306 can be positioned within the channel 608 and engaged with the teeth.

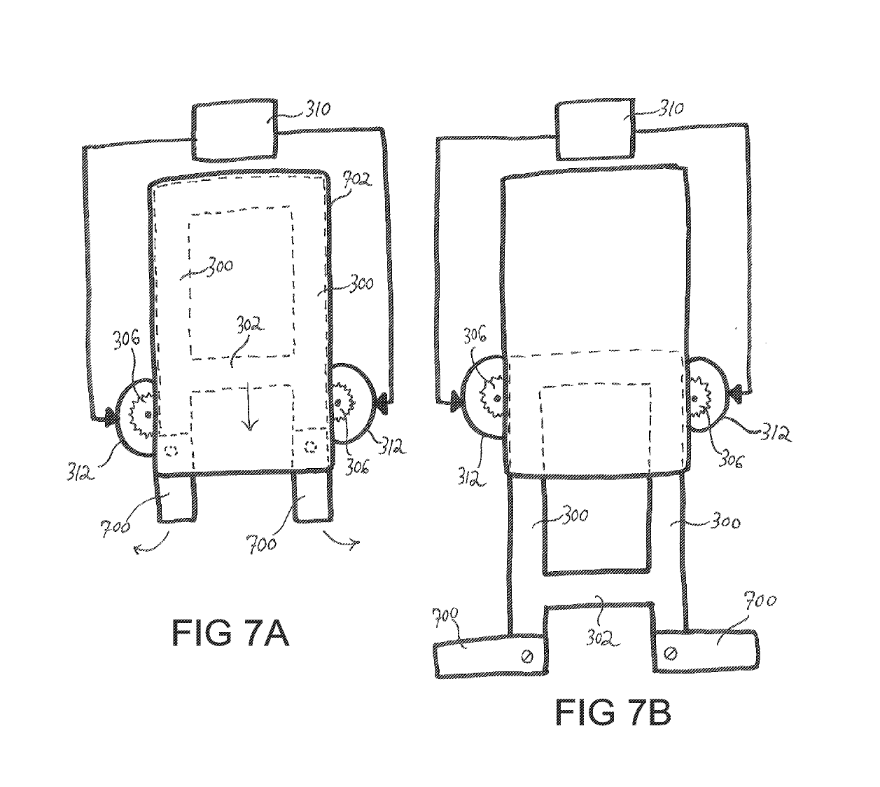

FIG. 7A illustrates a preferred embodiment of the motorcycle stand in which straight, mechanically extendable legs 300 are connected by a crossbar 302 and foldable feet 700 are connected to the legs 300. The stand is illustrated as being fully retracted and housed within a vertically upright stand frame 702. Two motor-driven gears 306 are shown as a leg extending mechanism. Separate gears 306 are engaged with each of the two legs 300 through slots in the stand frame 702, and each of the gears 306 is mechanically driven by its own separate motor 312. Each gear 306 is engaged with a toothed channel within a leg 300. A control unit 310 electronically sends a command to the motors 312, and the motors 312 rotate the gears 306 so as to extend or retract the legs 300. FIG. 7B illustrates the embodiment of FIG. 7A, with the legs 300 fully extended from the stand frame 702.

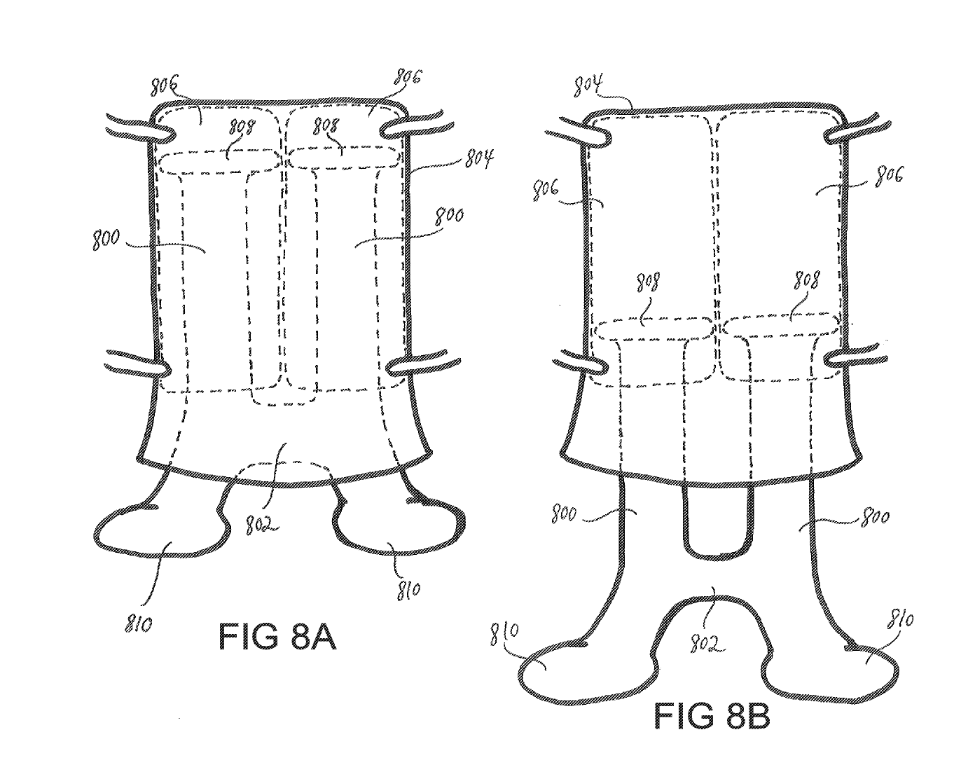

FIG. 8A illustrates a preferred embodiment of the motorcycle stand in which straight, hydraulically extendable legs 800 connected by a crossbar 802 are fully retracted and housed within a vertically upright stand frame 804. Each leg 800 functions as a separate piston rod 806, joined at the top to a piston head 808, and the pistons 806 are hydraulically driven by a single pump. In this embodiment the legs have circular feet 810 attached at their ends, instead of rectangular feet. FIG. 8B illustrates the embodiment of FIG. 8A, with the legs 800 fully extended from the stand frame 804.

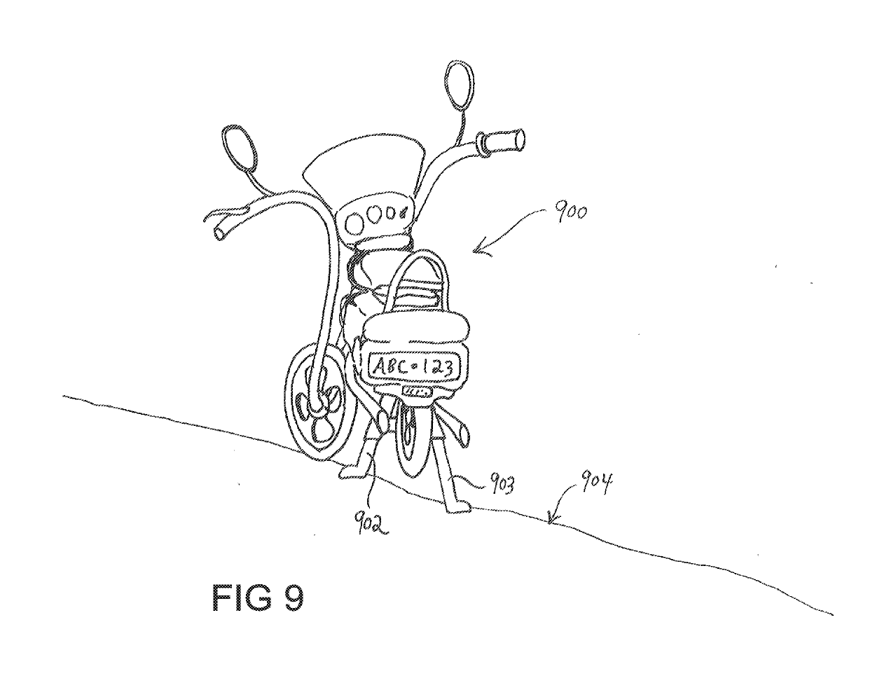

FIG. 9 is a rear view of a motorcycle 900, showing a preferred embodiment of the motorcycle stand attached to the undercarriage of a motorcycle behind the motor of the motorcycle 900. The stand has independently extendable legs 902, 903 shown as being extended to different lengths onto uneven terrain 904, so as to support the motorcycle 900 in a vertically upright position. As shown in FIG. 9, the right leg 903 of the motorcycle stand is extended further than the left leg 902, since the terrain 904 is sloped downward toward the right. A tilt sensor informs the motorcycle stand control unit as to whether the motorcycle 900 is tiled in a certain direction, and the control unit of the motorcycle stand compensates by commanding the leg extending mechanism to extend one leg 903 further than the other leg 902 until the motorcycle 900 is vertical.

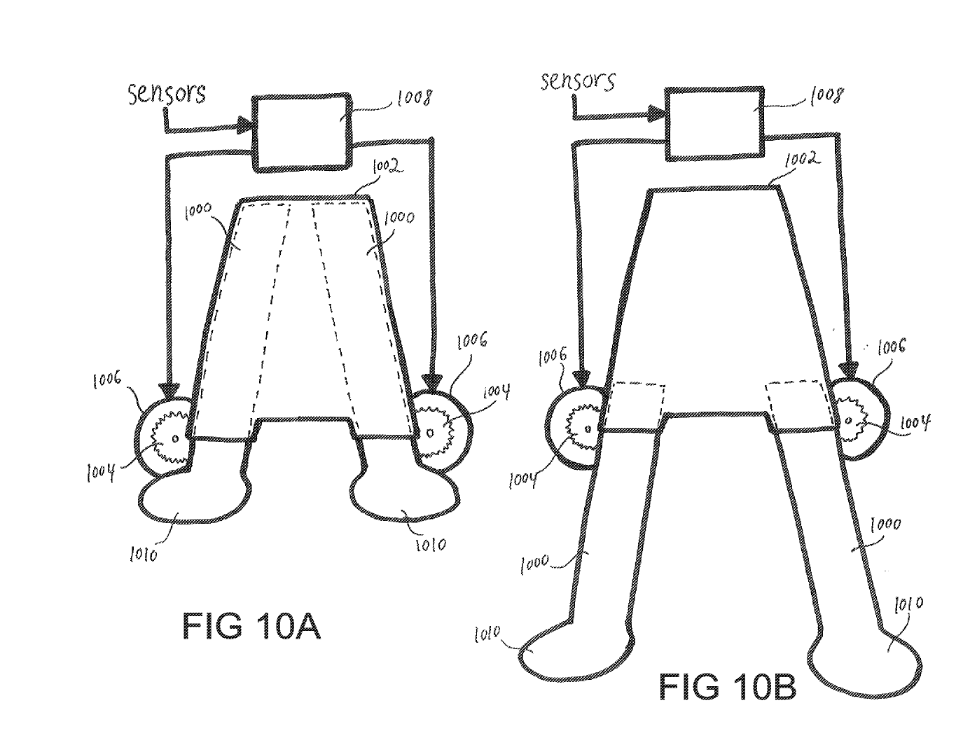

FIG. 10A illustrates a preferred embodiment of the motorcycle stand with independently extendable, mechanically driven legs 1000, shown in the figure as being fully retracted and housed within a vertically upright stand frame 1002. The legs are oriented such that they diverge when they are extended, thereby providing extra stability. Two motor-driven gears 1004 are shown as a leg extending mechanism. A gear 1004 is engaged with a toothed channel within each of the two legs through slots in the stand frame 1002, and the each of the gears 1004 is independently driven by a separate motor 1006. A control unit 1008 electronically sends a command to the motors 1006, and the motors 1004 rotate the gears 1004 so as to extend or retract the legs 1000. As shown in this figure, the legs can have circular feet 1010 attached at their ends, instead of rectangular feet. FIG. 10B illustrates the embodiment of FIG. 10A, with the legs 1000 independently extended from the stand frame 1002. Sensors inform the control unit 1008 whether the stand is supporting the motorcycle in a vertically upright position. This embodiment can be used on uneven terrain, such as the terrain shown in FIG. 9. Alternatively, a preferred embodiment of the motorcycle stand can have straight, independently extendable legs where each leg is driven by a separate hydraulic pump instead of a motor.

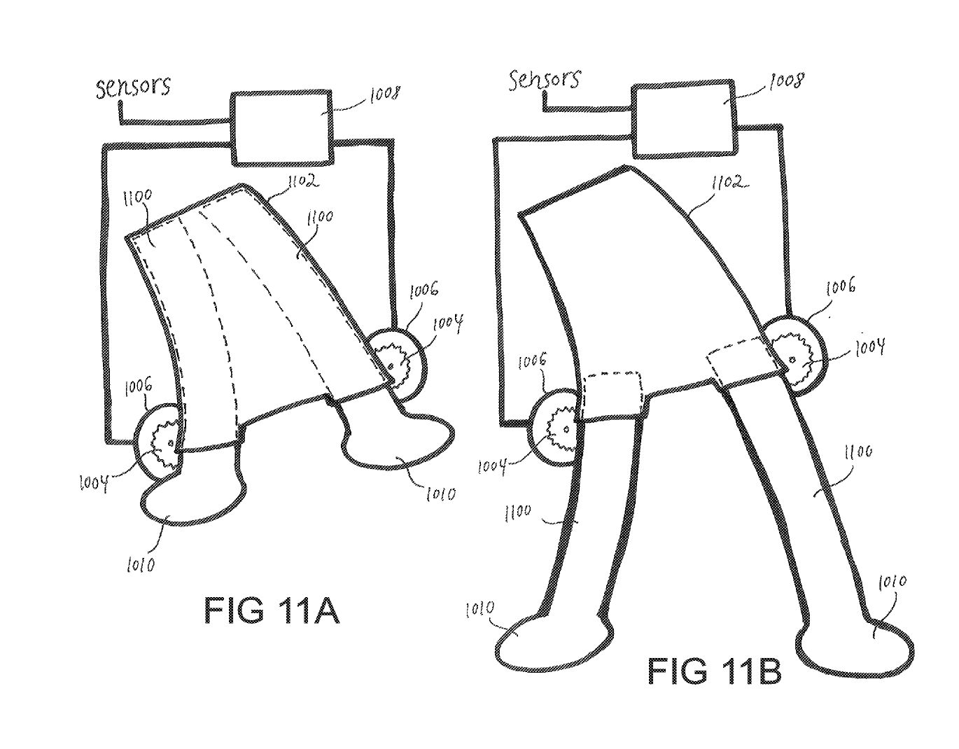

FIG. 11A illustrates a preferred embodiment motorcycle stand with curved, independently extendable, mechanically driven legs 1100 shown as being fully retracted and housed within a curved stand frame 1102. This embodiment is suitable for motorcycles that include a structural element that would otherwise interfere with installation of the stand frame 1102. In this embodiment the stand legs 1100 extend in an arc, so as to support the middle of the motorcycle when touching the ground. One leg is less dramatically curved than the other, so that the legs diverge when they are extended, thereby providing extra stability. Two motor-driven gears 1004 are shown as a leg extending mechanism. A gear 1004 is connected to each of the two legs through slots in the stand frame 1102, and the gears 1004 are independently driven by separate motors 1006. The gears 1004 are engaged with toothed channels within each of the legs 1100. A control unit 1008 electronically sends a command to the motors 1006, and the motors 1004 rotate the gears 1004 so as to extend or retract the legs 1100. As shown in this figure, the legs can have circular feet 1010 attached at their ends. FIG. 11B illustrates the embodiment of FIG. 11A, with the legs 1100 independently extended from the stand frame 1102. Sensors inform the control unit 1008 whether the motorcycle is in a vertically upright position. This embodiment can also be used on uneven terrain, such as the terrain shown in FIG. 9.

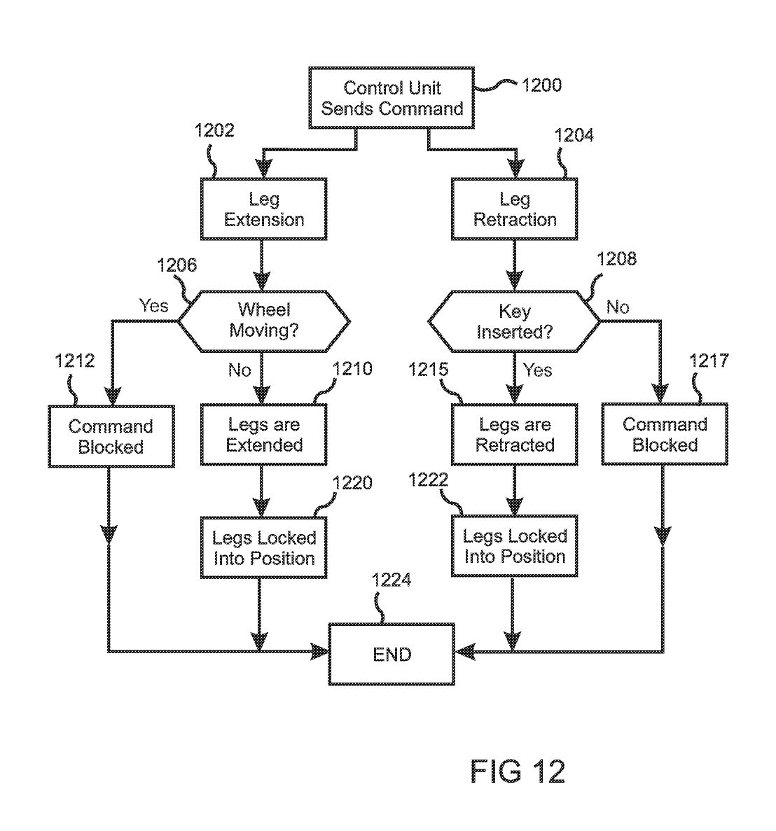

FIG. 12 is a flow diagram that illustrates the usage of the invention in a preferred embodiment wherein a safety mechanism and an anti-theft system intercept commands sent from a stand control unit to a leg extending mechanism. The stand control unit sends a command for the leg extending mechanism to extend or retract the legs of the stand 1200. If the command is for leg extension 1202, the safety mechanism uses a sensor to determine if a motorcycle wheel is moving 1206. If a wheel is moving, the command for leg extension is blocked 1212, thereby preventing the legs from being extended while the motorcycle is in motion. In similar embodiments the safety mechanism automatically retracts the legs if a wheel is moving. If no wheel is moving, the command for leg extension is allowed 1210, and the legs are extended and locked into position 1220. If the command is for leg retraction 1204, an anti-theft system detects whether a requisite key or passcode has been inserted 1208. If the required key or passcode has not been inserted, the command for leg retraction is blocked 1217, so that the legs cannot be retracted by someone who is not authorized to use the motorcycle. If the requisite key or passcode has been inserted, the command for leg retraction is allowed 1215, and the legs are retracted and locked into position 1222.

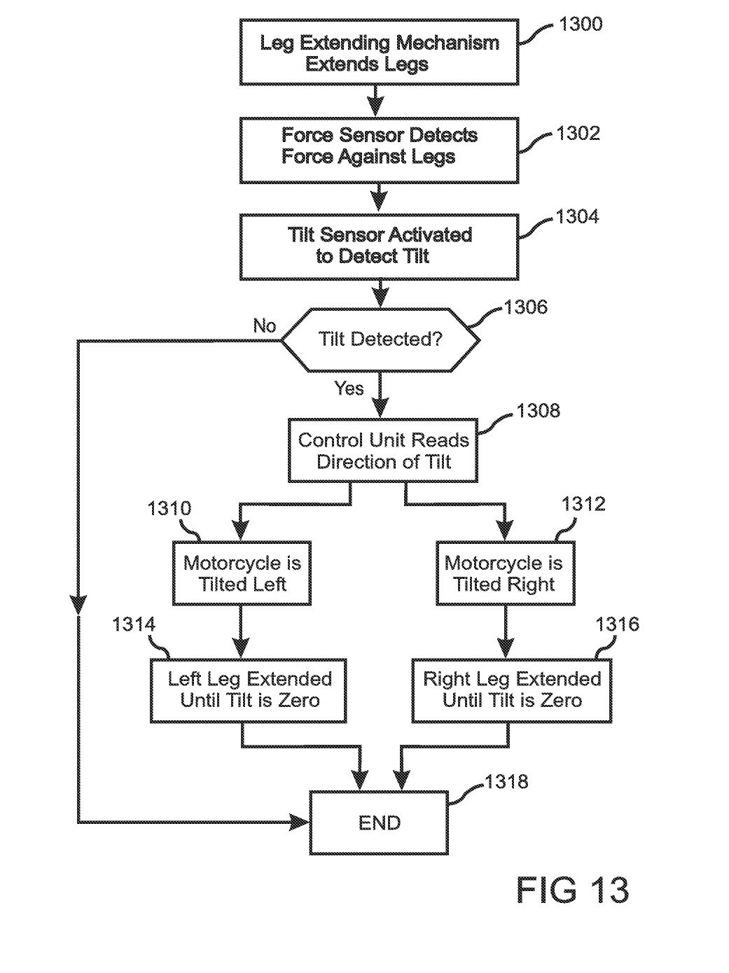

FIG. 13 is a flow diagram that illustrates usage of the invention in a preferred embodiment where a stand control unit adjusts individually extendable legs based upon the readings of a force sensor and a tilt sensor. The stand control unit sends a command for a leg extending mechanism to extend the legs of the stand 1300. The force sensor detects when force is applied to the ground by each of the legs 1302, indicating that the legs are touching the ground and supporting some of the weight of the motorcycle. Next, a tilt sensor is activated 1304, which detects whether the motorcycle is tilted 1306. If so, the control unit reads the direction of tilt 1308, and adjusts its commands accordingly. If the motorcycle is tilted to the left 1310, the control unit directs the leg extending mechanism to extend the left leg so as to raise the left side of the motorcycle until the motorcycle is no longer tilted 1314. Likewise, if the motorcycle is tilted to the right 1312, the control unit directs the leg extending mechanism to extend the right leg so as to raise the right side of the motorcycle until the motorcycle is no longer tilted 1316.

Other modifications and implementations will occur to those skilled in the art without departing from the spirit and the scope of the invention as claimed. Accordingly, the above description is not intended to limit the invention except as indicated in the following claims.

1. A powered motorcycle stand comprising:
at least two legs that are attachable to a motorcycle undercarriage, the legs being extendable to a right side and a left side of the motorcycle, so as to support the motorcycle in a standing orientation;
a powered leg extending mechanism that is able to extend and retract the legs; and
a stand controller that is able to control the powered leg extending mechanism.

2. The motorcycle stand of claim 1, wherein the legs are attachable to the motorcycle by at least one of welding, fastening with brackets, fastening with bolts, and fastening with clamps.

3. The motorcycle stand of claim 1, wherein the legs include at least one of tubular steel bars and solid steel bars.

4. The motorcycle stand of claim 1, further comprising at least one crossbar connecting the legs.

5. The motorcycle stand of claim 1, wherein the legs are housed in a stand frame when the legs are retracted.

6. The motorcycle stand of claim 1, wherein the legs are telescopically extendable.

7. The motorcycle stand of claim 1, further comprising a plurality of feet, wherein a foot is connected to the bottom of each leg.

8. The motorcycle stand of claim 1, wherein the powered leg extending mechanism includes an electric motor.

9. The motorcycle stand of claim 8, wherein the electric motor is able to apply a rotational force to a driving gear.

10. The motorcycle stand of claim 9, wherein at least one leg of the plurality of legs includes one of a toothed side and a toothed channel that is engaged with the driving gear, so as to cause the leg to be one of extended and retracted when the electric motor applies a rotational force to the driving gear.

11. The motorcycle stand of claim 1, wherein the powered leg extending mechanism includes a hydraulic pump and piston.

12. The motorcycle stand of claim 1, wherein the motorcycle stand is able to provide optimal stability when the motorcycle is located on uneven terrain by extending the legs to different extents, such that the legs support the motorcycle in an upright position.

13. The motorcycle stand of claim 12, further comprising a sensor that detects at least one of the force of resistance against a plurality of extended legs and the lateral tilt of the motorcycle.

14. The motorcycle stand of claim 1, wherein the visibility of the stand is minimized when the legs are retracted.

15. The motorcycle stand of claim 1, wherein the stand controller includes a manually operable control affixed to a dashboard of the motorcycle.

16. The motorcycle stand of claim 1, further comprising a locking mechanism that is able to lock the legs in place when extended.

17. The motorcycle stand of claim 1, wherein the stand controller includes an anti-theft system that is able to inhibit an unauthorized user from retracting the legs.

18. The motorcycle stand of claim 17, wherein the anti-theft system requires at least one of insertion of a key and entry of a code so as to initiate retracting of the legs.

19. The motorcycle stand of claim 1, wherein the stand controller includes an automatic safety system that operates when the motorcycle is in motion by at least one of automatically retracting the legs, and automatically preventing extension of the legs.

20. The motorcycle stand of claim 19, wherein the safety system includes a sensor that detects when at least one wheel of the motorcycle is rotating.
